(19) United States
(12) Patent Application Publication
(10) Pub. No.: US 2016/0380820 A1
(43) Pub. Date: Dec. 29, 2016

(54) Reconfiguring Wireless Networks By Predicting Future User Locations and Loads

(71) Applicant: Microsoft Technology Licensing, LLC, Redmond, WA (US)

(72) Inventors: Eric Joel Horvitz, Kirkland, WA (US); Ranveer Chandra, Bellevue, WA (US)

(21) Appl. No.: 14/753,716

(22) Filed: Jun. 29, 2015

(51) Int. Cl. H04L 12/24; H04W 28/08; H04W 16/18; H04W 8/00; H04W 16/28; G06N 5/04; H04W 4/02

(52) U.S. Cl. CPC H04L 41/0816; G06N 5/04; H04W 28/08; H04W 4/02; H04W 8/005; H04W 16/28; H04W 16/18; H04W 84/12

(57) ABSTRACT

Wireless networks may be dynamically reconfigured based at least in part on predicted future user device locations. The predicted future user device locations may be used to, for example, to offload user devices to small cells or WiFi networks. The predicted future user device locations may additionally or alternatively be used for targeting directional signals and/or for beam forming for multi-user multi-input/multi-output systems.

### BACKGROUND

Currently wireless cellular networks are typically statically configured. Cellular network carriers perform measurements and use propagation models to decide where to put network base stations during a planning phase. Parameters for the base stations are not very dynamic and are typically changed manually, if at all. Statically configured networks are unable to adapt to changes in loads, interference, and other changing conditions. Recently, some wireless cellular networks have begun to enable reconfiguration based on current network traffic conditions. However, reconfiguring networks based on current network traffic conditions is problematic because current conditions are not necessarily representative of traffic conditions of the network in the near, medium, or distant future. Moreover, existing systems do not take into account external conditions that may impact the network in the future.

### SUMMARY

Technologies are described herein for reconfiguring wireless networks based on predicted future conditions, such as predicted future locations of one or more user devices. According to aspects presented herein, a network base station, web service, or other computing device may determine locations of one or more user devices, predict future locations of the one or more user devices and reconfigure wireless network services based on the locations and/or predicted future locations of the one or more user devices. For example, in some instances, the computing device may determine whether to offload one or more user devices from a macro cellular network to a small cell network or a Wi-Fi network based at least in part on the predicted future location of the user device. Additionally or alternatively, the locations and/or predicted future locations of the one or more user devices are usable alone or in combination with other information to determine and/or configure future channel conditions of the network (e.g., intensity, direction, number of beams, communication channels to use).

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicates similar or identical items.

FIG. 1 is a system diagram showing aspects of an example system disclosed herein for reconfiguring wireless networks which includes offloading a user device from a base station to a small cell or WiFi network;

FIG. 2 is a system diagram showing aspects of an example system disclosed herein for reconfiguring wireless networks by showing potential future locations of a user device;

FIG. 3 is a system diagram showing aspects of an example system disclosed herein for reconfiguring wireless networks by sending a directional link to one or more predicted future locations of user devices;

FIG. 4 is a flow diagram showing an example process that illustrates aspects of the operation of the system illustrated in FIG. 2 relating to reconfiguring wireless networks;

FIG. 5 is a flow diagram showing an example process of sending a directional signal to a predicted future location of a user device;

FIG. 6 is a computer architecture diagram illustrating an example computer hardware and software architecture for a computing system capable of implementing aspects of the technologies presented herein; and

FIG. 7 is a diagram illustrating an example distributed computing environment capable of implementing aspects of the technologies presented herein.

### DETAILED DESCRIPTION

### Overview

As discussed above, existing cellular wireless networks are typically statically configured or allow for reconfiguration based on current network traffic conditions. Statically configured networks often do not respond to demands in a dynamic manner. Such existing networks are not reconfigurable based on predicted future locations of user devices, nor do they take into account external conditions that may impact the network in the future.

The techniques described herein provide the ability for reconfiguring cellular wireless networks based at least in part on one or more predicted future locations of user devices. The one or more predicted future locations for each user device may define one or more potential routes of the user device from a current location to the predicted future locations over time. As will be described in more detail, utilizing the predicted future locations of user devices allows for increased efficiency and performance of the network by, for example, offloading a user device to an offload network while minimizing signaling overhead. Other examples include performing intelligent device discovery and transmission using directional signals based on predicted future locations of user devices.

The following detailed description is directed to technologies for reconfiguring wireless networks based at least in part on future user device locations. In particular, a predicted future location of a user device may be obtained by a wireless network. In some examples, the location prediction may be performed locally by the wireless network (e.g., at one or more base stations, back office servers, a data center, or the like). In other examples, the location prediction may be performed by a third party service (e.g., a cloud based location service). Regardless of the location from which the location prediction is obtained, the wireless network may use this predicted future location to determine an amount of time that the user device is predicted to be within range of an offload network. The wireless network may switch the user device from a base station on the wireless network to the offload network based at least in part on the amount of time that the user device is predicted to be within range of the offload network. The offload network may comprise a small cell (e.g., picocell, microcell, femtocell) or another technology, such as a Wi-Fi or a TV white space network. Additionally or alternatively, the wireless network may switch the user device to the offload network based at least in part on a predicted rate of motion of the user device, a geographic size and coverage of the offload network, a current load on the wireless network and/or a cost (e.g., in terms of processing resources, bandwidth, power consumption) associated with offloading the user device.

Wireless networks may also utilize a predicted future location of a user device to send directional signals from a wireless network to the user device. A directional signal sent to the predicted future location may be based at least in part upon the probability of the user device appearing at the predicted future location. Additionally or alternatively, the directional signal may comprise a beam of varying width. The directional signal may connect to one or more user devices simultaneously. In one configuration, the directional signal may connect to multiple devices by varying a width of the beam sent out. In some examples, the width of the beam is based at least in part on the probability of the user device appearing at the predicted future location. Directional signals can be used in multiple technologies such as millimeter wavelengths. Directional signals can be implemented in different manners, including beam steering and phased array antennas.

Millimeter wavelength technology may be used in multi-user multiple-input and multiple-output systems (MU-MIMO). MU-MIMO may use multiple antennas to send and receive signals both at the user device and the wireless network base station or access point. MU-MIMO may also utilize the predicted future location of the user device, at least in part, to base a determination of future wireless channel conditions. The future channel conditions may be used to plan future wireless services. The future channel conditions may encompass intensity, direction, number of beams, and communication channels to use, among other conditions.

As mentioned above, in some examples, a MU-MIMO system may use millimeter wave technology. Millimeter wave technology is also known as extremely high frequency (EHF). As used herein, millimeter wave means transmissions having frequencies of from 30 to 300 gigahertz (GHz). Operating in the EHF spectrum allows for higher data transmission rates due to the higher frequency. Additionally, since the wavelengths are small, antennas transmitting millimeter waves may also be small. The MU-MIMO system may utilize millimeter wave technology with smaller antennas, to bundle multiple antennas closely together to send and receive signals. The MU-MIMO system may utilize the predicted future locations of multiple user devices to send a directional beam of specified width to the multiple user devices. In other examples, a MU-MIMO system may employ additional or alternative wireless technologies.

The foregoing techniques and concepts may be practiced individually or in combination with each other. Examples and additional details of each of these techniques are described below with reference to the accompanying figures, which are shown by way of illustration of specific configurations or examples.

Beyond the use of future locations predicted under uncertainty, key ideas on optimizing configuration of wireless assets and assignments can be employed with more deterministic contracts that specify the likely locations and needs over time for devices that may be in motion or planned to be at sequences of different locations over time. Set of such space-time projections or space-time contracts can be employed in the optimizations discussed.

### Example Location Prediction

The techniques described herein provide the ability for reconfiguring wireless networks based upon at least a prediction of future user device locations. Predicting the destination of a user while riding in an automobile is an example of location prediction of a user device. In some examples, all potential destinations are calculated within a certain range of a user device. This range may be based on distance (e.g., miles or kilometers) or based upon travel time. The method calculates a probability of the user device appearing at each potential destination based upon at least the range. Additionally or alternatively, the method may also calculate probabilities based upon past driving behavior or other contextual information (e.g., traffic conditions, reports of road construction, calendar appointments in a user's calendar, and addresses of contacts in a user's address book). As the user device begins to move, the method updates the range to each previously predicted future user device location. The method updates the calculated probabilities to each predicted future user device location. The method may weight against predicted locations with increased ranges to quickly decrease their updated probability. Additionally or alternatively, the method may also recalculate probabilities when the user device travels across intersections along the roads. Additional details of the foregoing location prediction techniques can be found in J. Krumm and E Horvitz. Predestination: Inferring Destinations from Partial Trajectories, UbiComp 2006: International Conference on Ubiquitous Computing, September 2006, Irvine, Calif., USA, ACM 2006 and Horvitz et al., Some Help on the Way: Opportunistic Routing under Uncertainty, UbiComp 2012: International Conference on Ubiquitous Computing, September, 2012, Pittsburgh, USA, ACM 2012.

The previous examples are two related methodologies that serve as examples of many possible location prediction techniques. Other operations are possible, including means for acquiring or assessing plans or commitments for being at different locations over time for individuals, or on statistics of mobility for larger populations, without departing from the scope and spirit of the present description, with the foregoing examples provided only to facilitate this discussion.

### Example Operating Environment

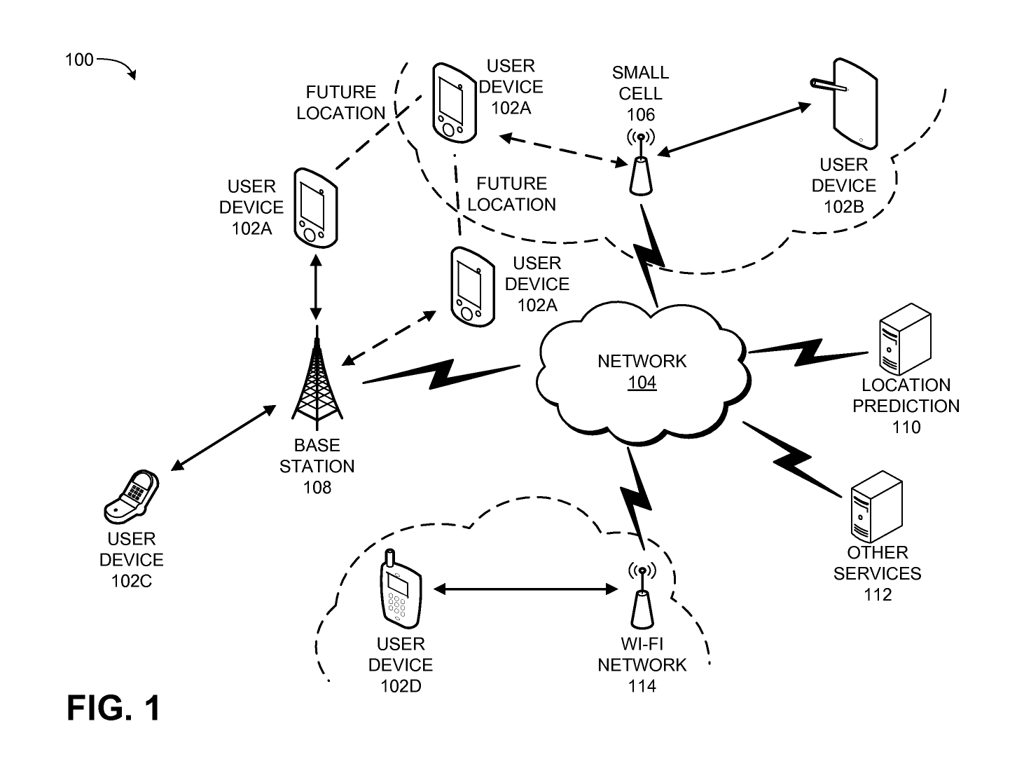

Turning now to FIG. 1, details will be provided regarding an example operating environment and several software components disclosed herein. In particular, FIG. 1 is a system diagram showing aspects of an example system for reconfiguring wireless networks based at least in part upon predicted future locations of user devices. The system 100 shown in FIG. 1 includes a number of user devices 102A-102D (hereinafter referred to collectively and/or generically as “user devices 102”). The user devices 102 are located on different portions of a network 104. The user devices 102 may refer to any number of computing devices, working alone or in concert, capable of sending and/or receiving wireless transmissions. For example, and without limitation, the user devices 102 may refer to laptop computers, tablet computing devices, mobile phones, navigation devices, automobile computers, or other devices.

FIG. 1 shows numerous user devices 102 located on different portions of a network 104. The user devices 102 are connected to the network 104 through base stations 108, small cells 106 and Wi-Fi networks 114. Base stations 108 may include base stations utilizing one or more mobile telecommunications technologies to provide voice and/or data services. The base stations 108 are representative of macro cells in this example. The mobile telecommunications technologies can include, but are not limited to, Global System for Mobile communications (“GSM”), Code Division Multiple Access (“CDMA”), CDMA ONE, CDMA2000, Universal Mobile Telecommunications System (“UMTS”), General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE (“Long-Term Evolution”), and various other wireless standards for 2G, 3G, 4G and 5G and other current and future wireless standards.

Offload networks may include small cells 106 and Wi-Fi networks 114. Small cells 106 may include picocells, microcells, femtocells and other network cells smaller than a macro cell. In some examples, various small cells have ranges of about ten meters up to about three kilometers. Wi-Fi networks 114 include networks implementing one or more Institute of Electrical and Electronic Engineers (“IEEE”) 802.11 standards, such as IEEE 802.11a, 802.11b, 802.11g, 802.11n, 802.11ac and/or a future 802.11 standard.

FIG. 1 illustrates the range of the small cell 106 and Wi-Fi networks 114 using dashed lines. In this example, the system offloads user device 102A from the base station 108 to the small cell 106 and then back to the base station 108. In other examples, the user device 102A may travel the same route but never switch to the small cell 106. The system 100 may consider a length of time that the user device 102A is predicted to be within range of the small cell 106 in determining whether to switch the user device 102A to an offload network such as the small cell 106.

To determine the predicted length of time, the system 100 may consider factors such as the range of the small cell 106, a route of the user device 102A through the range of the small cell 106 (e.g., is the user device predicted to pass along a periphery of the range of the small cell, or through its center), a rate of motion of the user device 102A, and the like. Therefore, the user device 102A may travel the same route but not be switched to an offload network because the system determines that the user device 102A may not be in range of the offload network for a sufficient length of time (e.g., a threshold amount of time) for the benefits of the offload to outweigh the signaling overhead and other costs associated with offloading the user device.

This system can make this determination by using predicted future user device 102A locations, along with the rate of motion of the user device 102A and the range of the small cell 106. Additionally or alternatively, other factors can be considered in this determination including a current load on the base station 108, a current load on the small cell 106, a predicted future load on the base station 108, a predicted future load on the small cell 106, a predicted location of other user devices 102, and/or service level or quality of service agreements associated with the user device and/or other user devices.

The network 104 may also include a location prediction module 110. The location prediction module 110 calculates predicted future locations of the user devices 102. The predicted future locations of the user devices may be associated with likelihoods or certainties that the user devices 102 will appear at the respective future locations. In some examples, predicted future locations over time can also be captured as assessed plans or committed contracts with people over time. This predicted future location information may then be shared through the network 104 to the offload networks, the base stations 108, and/or the user devices 102. The system 100 illustrates the location prediction module 110 in a cloud computing architecture. Alternatively, the location prediction module 110 could be located elsewhere in the network 104 such as, but not limited to, central office servers of the network, the small cells 106, the Wi-Fi networks 114 and/or the base stations 108.

In addition to the location prediction module 110, the network 104 may contain other elements represented as the other services module 112. The other services module may include a traffic conditions module and/or a weather conditions module, for example. The traffic conditions module may report current traffic conditions of a geographic area of the network 104. Traffic conditions may include, but are not limited to, automobile traffic, road construction, airport traffic, mass transit traffic and/or pedestrian traffic.

The traffic conditions may be utilized by the location prediction module 110 to predict future locations, routes, and/or rates of motion of the user devices 102. For instance, the traffic conditions module may determine that a user device 102 is likely to take a detour to avoid traffic, or that the user device 102 is stuck in traffic and will therefore likely move more slowly for a period of time. Additionally, the location prediction module 110 may determine that a large population will likely attend an event at a certain time and then leave for another event. These methods utilized by the location prediction module 110 can be scaled to statistics of population as well, including such issues as traffic loads expected in the future at locations. See: E. Horvitz, J. Apacible, R. Sarin, and L. Liao. Prediction, Expectation, and Surprise: Methods, Designs, and Study of a Deployed Traffic Forecasting Service, Proceedings of the Conference on Uncertainty and Artificial Intelligence 2005, AUAI Press, July 2005.

The weather conditions module may report current and/or future weather conditions of the geographic area of the network 104. The weather conditions may be utilized by the location prediction module 110 to predict future locations of the user devices 102. The weather prediction module may also be utilized by a channel condition module to predict changes in channel conditions due to weather (e.g., interference, power outages).

Information from these modules may then be shared through the network 104 to the offload networks (e.g., the small cell 106 and the Wi-Fi network 114), the base stations 108, and/or the user devices 102. The system 100 illustrates these modules in a cloud computing architecture. Alternatively, the modules may be located elsewhere in the network 104. Additionally, other modules may be located on the other services module 112 that provide information to the network 104 and may be utilized by the location prediction module 110 to calculate future locations of the user devices 102.

The network 104 may utilize the predicted future locations of the user devices 102 in a variety of ways. The manner in which the network 104 utilizes the predicted future locations may include determining to offload traffic to one or more offload networks, determining future channel conditions at the predicted future locations and adjusting transmissions accordingly, and/or configuring and sending directional signals to the predicted future locations.

Additionally or alternatively, the network 104 may provide more stable and reliable coverage to a user device 102 by utilizing a predicted future location. The predicted future location may be utilized to compute potential routes to the predicted future locations. The wireless network may utilize this predicted location data to provide a signal to the user device 102 as soon as the user device 102 appears in coverage. Moreover, the signal may be provided to the user device 102 without typical signaling overhead since the network has advanced knowledge of the location of the user device 102. Reduction of signaling overhead increases network efficiency by reducing the network traffic and/or processing load of the network. This reduction in signaling overhead also reduces the power consumption by the user device 102, thereby prolonging the battery life of the user device 102.

The potential routes to the predicted locations may be computed by the location prediction module 110. Each predicted location and each route has a certain probability that the user device 102 may actually travel the route to arrive at the future location. These predicted locations and routes, and the associated probabilities of each, may be utilized in order to make more intelligent decisions about where to focus signals. For instance, in some examples a base station may focus a signal in a narrow beam to capture the single most probable location. In other examples, such as where multiple predicted future locations all have a relatively equal probability, a base station may focus a relatively narrow beam signal at each of the predicted future locations. Alternatively or additionally, a base station may focus the signal in a wider beam that captures the multiple potential future locations, but at some cost to signal strength.

The network 104 may utilize the predicted future locations of user devices 102 to determine when to offload user devices 102 from the network 104 to a small cell 106 or a Wi-Fi network 114. The system 100 illustrates small cells 106 and Wi-Fi networks 114 as offload networks. The offload networks are connected to the network 104 via backhaul networks such as the Internet. When user devices 102 are offloaded from the network 104, the user devices 102 are removed from base stations 108, or other macro cells, to an offload network. These offload networks are connected to the network 104 but offer advantages. A network provider may or may not own all or any of the offload networks. Since the network provider may or may not own the offload networks, the traffic from the user devices 102 on the small cells 106 and Wi-Fi networks 114 is considered “offloaded.” These offload networks are typically cheaper for the network provider to operate. Additionally, use of the offload networks allows for additional capacity on the base stations 108.

### Example Offloading to Small Cells

The determination to offload a user device 102 to an offload network may depend on multiple factors. These factors may include, but are not limited to, the amount of time the user device 102 is predicted to remain within range of the offload network. In some examples, when the user device 102 is predicted to be within range of the small cell 106 longer than a threshold amount of time, the user device 102 may be offloaded to the small cell 106. By way of example and not limitation, factors that may be considered when determining whether to offload user devices 102 to an offload network include the proximity of the predicted future location of the user device 102 to the center of the offload network, the geographic size of the offload network, a predicted rate of motion of the user device 102 at the predicted future location, the current and/or predicted future load on the offload network, the current and/or predicted future load on the base stations 108, the predicted future location of other user devices 102, a cost associated with offloading the user device 102 and the service quality of the offload network.

The cost associated with offloading the user device 102 may include the time to leave the current base station 108 or offload network, the time to join the offload network, impact to battery life of the user device 102, increase in network traffic to accomplish the handoff to the offload network, and/or the probability of a call being dropped at the user device 102. Likewise, the quality of the offload network may include various pieces of information including the signal strength of the offload network, the current number of user devices 102 utilizing the offload network and a predicted number of devices on the offload network when the user device 102 is predicted to be in range of the offload network.

As discussed above, the determination to offload a user device 102 to an offload network may depend on multiple factors. In some examples, multiple factors may be utilized together based upon a weighted framework. For example, the decision to offload a user device 102 could be made when the predicted future path of the user device 102 will be within range of an offload network longer than a threshold amount of time, so long as the load on the offload network is not above a certain load. When the load on a base station 108 is high, the acceptable load for an access point 106 to have and still allow offloading, may also rise. It should be appreciated that more or fewer factors may be weighted than in the above example. For example, the determination to offload a user device 102 to an offload network may depend only on the probability of the user device 102 appearing at the predicted future location.

A network provider may implement a number of these weighted factors as network and user device settings. The network provider may implement some of these settings by incentivizing users to opt-in to a service with a reduced cost or other features, in exchange for allowing the network provider to choose when the user device 102 will be switched from a base station 108 to an offload network such as a small cell 106 or Wi-Fi network 114. As an example, by opting in the user may agree to turn on the Wi-Fi settings of their user device 102.

As discussed above, the system 100 may experience performance improvements from implementing prediction of future user device locations with regard to offloading the user devices 102. These performance improvements may include power savings from reduced network scanning since the network 104 knows when the user device 102 will be in range of a new offload network. In addition to benefiting from additional base station 108 capacity once user devices 102 are offloaded, the system 100 may also benefit when the user device 102 is not offloaded, since a user device 102 may not be offloaded when the predicted location of the user device 102 indicates that the user device 102 will not be in range of the offload network for a substantial period. In these situations, the system 100 will save the signaling overhead that the user device 102 would have incurred by both leaving a base station 108 and consequently quickly returning to a base station 108 after a brief period on an offload network.

Network efficiency is also increased by providing stronger and faster links to user devices 102 by utilizing knowledge of future locations of user devices 102. Knowing the future locations of user devices 102 allows the network to predict future loads on the network. Additionally, both the user device 102 and the network 104 may utilize the predicted future location of a user device 102 to plan for and/or avoid potential service disruption.

Additionally, knowing the future locations of user devices 102 allows the network to predict future routes of the user devices 102. A predicted route can be used to infer a time when the user device 102 may appear at a location in the future. The predicted route may also be used to plan locations of mobile base stations. Mobile base stations, such as drones, balloons, or other autonomous vehicles may be placed and/or moved based upon the predicted routes of user devices 102. Such mobile base stations may temporarily provide service in areas that have limited or no other service.

### Example Transmission Techniques

The network 104 may utilize the predicted future locations of user devices 102 to send directional signals to the predicted future locations of the user devices 102. Directional signals can be used in multiple technologies including millimeter wavelengths. Millimeter waves are also known as extremely high frequency (EHF). As used herein, millimeter wave means transmissions having frequencies of from 30 to 300 gigahertz (GHz). Operating in the EHF spectrum allows for higher data transmission rates due to the higher frequency. Additional benefits of the EHF spectrum include small frequency reuse distances and cleaner spectrum. Frequency reuse increases both coverage and capacity of the cellular network. Signals in this EHF spectrum tend to be weaker and are easily blocked. At 60 GHz, signals begin to dissipate in the air.

One way to counter the weaker signals in this spectrum is to send directional signals rather than omni-directional signals. Typically, a base station 108 or offload network using millimeter waves sends out weaker omni-directional signals. Once the user device 102 receives an omni-directional signal and responds back, then directional signals may be sent to the user device 102 from the base station 108 or offload network using millimeter waves. In this process of beam scanning, the range of a base station 108 implementing this logic is limited to the range of an omni-directional signal.

By predicting future user device locations, the location prediction module 110 is able to transmit predicted future locations of a user device 102 to a base station 108 proximate to one or more of the predicted future locations that is utilizing the EHF spectrum. The base station 108 can then utilize this information to send a directional signal to one or more of the predicted future user device locations. As discussed above, the user device 102 can access the base station 108 with a reduced signaling overhead. Additionally, by providing the predicted future user device locations to the base station 108, the range of the base station 108 is increased beyond the limits of sending an omni-directional signal. That is, the base station 108 may discover the user device 102 by sending longer range targeted directional signals to the predicted future location(s) of the user device 102, rather than using the shorter range omni-directional signals. Also, as discussed above, the network 104 may provide stronger and faster links to the user devices 102 by utilizing knowledge of future locations of user devices 102. In some configurations, a number of beams, direction of beams, width of beams, and strength of the directional beams sent to the user device 102 can be based upon the probability associated with each of the predicted locations of the user device 102.

Millimeter waves have smaller wavelengths which allow for using smaller antennas to send and receive data. Since the antennas are small, it is possible to group or pack multiple antennas together. By grouping antennas together, a base station 108, offload network or user device 102 can send multiple signals to meet at a certain location where the signal is amplified. This amplification of signals is known as beamforming. This beamforming amplification may be accomplished through horn antennas or phased-arrays. Horn antennas focus signals in a certain direction. Phased-arrays amplify a signal by sending multiple sine waves. When these sine waves meet at a designated location the sine waves can be amplified. Additionally, it is possible for the sine waves to be diminished or nulled when the waves meet at a designated location. As will be discussed further below, grouping multiple antennas together also allows for MU-MIMO.

In addition to beam scanning, networks implementing EHF spectrum also often utilize beam planning. Beam planning determines how many beams a base station 108 will send to cover the user devices 102 it is currently serving. The signal-to-noise ratio for a base station 108 may be low if each user device 102 at a base station 108 has its own dedicated directional signal. Conversely, in situations where the base station 108 is sending the same data to multiple user devices 102, wider beams can be sent to reach multiple user devices 102. For example, the base station 108 may broadcast a video that multiple user devices 102 are viewing at the same time.

If a base station 108 is provided with a predicted future user device location, then the base station 108 can utilize this information to schedule its beam planning for future demands rather than reacting to current conditions on the fly. This beam planning results in more efficient use of the resources of the network.

### Example MU-MIMO Techniques

The network 104 may utilize the predicted future locations of user devices 102 to determine future channel conditions on the network 104 at the predicted future locations. Determining future channel conditions is advantageous when using MU-MIMO because it eliminates the need to determine channel conditions when the user device 102 is not present. Additionally, determining future channel conditions allows a MU-MIMO system to establish faster and stronger links with a user device 102. The future channel conditions may encompass intensity, direction, number of beams, and communication channels to use, among other conditions.

MU-MIMO utilizes multiple streams to improve capacity (e.g., utilizing two antennas to double capacity). MU-MIMO can be implemented on both the downlink channel and the uplink channel. When multiple streams are received, additional computations are often employed to determine the original signal sent via the multiple streams. Base stations 108 may implement sending information to multiple user devices 102 using multiple antennas, where each antenna is sending signals for more than one user device 102. MU-MIMO may be implemented in the EHF spectrum utilizing multiple antennas.

As discussed above, a MU-MIMO system also benefits from a predicted future user device location. The benefits include reduced signaling overhead and stronger and faster links with the user devices 102. In a MU-MIMO system, the signaling overhead may be large, especially when the user device 102 is moving.

A MU-MIMO system utilizes a predicted future user device location by also determining estimates of channel conditions at the predicted future user device location. Channel conditions may be based upon location, so knowing a route that a user device 102 is traveling (or one or more predicted routes that the user device 102 may be traveling with varying probabilities) allows the network to predict the channel conditions along the route. Additionally or alternatively, the predicted channel conditions may be calculated using current channel conditions, historic channel conditions, predicted traffic conditions, and/or weather conditions. Often, the channel conditions for a particular location may be determined ahead of time by the network 104. The network 104 may maintain the channel conditions of the various locations within the network area in a table or other data structure. The table then may be referenced by the network 104 to determine the channel conditions at any particular location within the network 104.

Similarly, a system implementing millimeter waves may also utilize such a location based table. As discussed above, millimeter waves may be easily obstructed. Therefore, the system implementing millimeter waves could utilize a location based table when using beam planning to avoid or minimize obstructions.

### Example Methods

Various methods are available for reconfiguring wireless networks based on predicted future conditions, such as predicted future locations of one or more user devices 102. One example method is a network management method comprising predicting possible future locations of a user device 102. The method may further determine a probability associated with the user device 102 appearing at each of the possible future locations. A signal may be sent from the network 104 to one of the predicted future locations based upon the probability of the user device 102 appearing at the respective predicted future location. Additionally or alternatively, the network 104 may send signals to multiple predicted future locations of the user device 102 based upon at least the probability of the user device 102 appearing at the predicted future locations.

Additionally or alternatively, the network 104 may vary the properties of the signals sent to one or more predicted future locations based upon at least the probability of the user device 102 appearing at the predicted future locations. These signal conditions may include but are not limited to direction of a signal, the width of the signal, the number of signals sent and/or the intensity of the signals. Other operations are possible without departing from the scope and spirit of the present description, with the foregoing examples provided only to facilitate this discussion. The subject matter described herein may be implemented by a computer-controlled apparatus, a process implemented at least in part by a computer, a computing system, or as an article of manufacture such as a computer-readable medium.

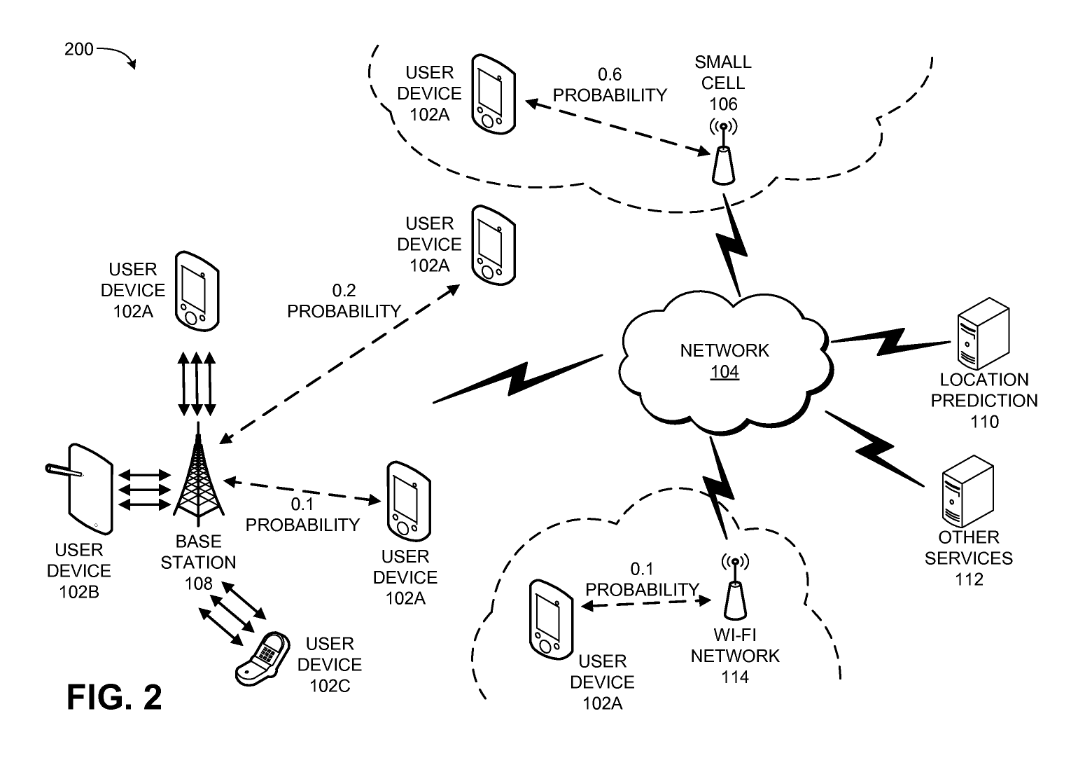

Referring now to FIG. 2, additional details regarding reconfiguring wireless networks by predicting future user device 102 locations are described. In particular, the system 200 illustrates a location prediction module 110 providing multiple future user device 102A locations to the network 104. The system 200 illustrates the probability associated with each predicted future location. Additionally, the system 200 illustrates a possible wireless link for each of the predicted future locations.

The user device 102A in this example is currently in communication with the base station 108. The user device 102A has a thirty percent combined probability of being in a coverage area normally serviced by the base station 108. Additionally, the user device 102A has a ten percent probability of being in a coverage area normally serviced by the Wi-Fi network 114 and a sixty percent probability of being in a coverage area normally serviced by the small cell network 106. As discussed above, the decision to offload a user device 102 to an offload network may be based in part on the predicted future location of the user device 102. Other factors may also weigh in the decision to offload the user device 102 to an offload network. These factors may include the amount of time the user device 102 is predicted to remain within range of the offload network, the current load on the offload network, the current load on the base stations 108, the predicted future location of other user devices 102, a cost associated with offloading the user device 102 and the quality of the offload network. As discussed above in some examples, multiple factors may be utilized together based upon a multiple weighted framework. More or fewer factors may be weighted than listed in the above example.

In addition to offloading, the system 200 also illustrates an EHF system where the small cell 106 links to the user device 102 with a directional signal, as soon as the user device 102 comes in range of the access point 106. The future user device location predicted by the location prediction module 110 allows the small cell 106 to link to the user device 102 without the normal signaling overhead. The small cell 106 operating in a millimeter wave spectrum, expands its coverage area by using directional signals, which are stronger than omni-directional signals. The small cell 106 may use directional signals based upon the probability of the future user device location predicted by the location prediction module 110.

Similarly, the system 200 also illustrates a MU-MIMO system. As discussed above, a MU-MIMO system may be implemented in the millimeter wave spectrum. Also, both the MU-MIMO system and an EHF system can utilize predicted future user device locations to predict the link quality at the future user device locations via a location based table. Additionally or alternatively, a MU-MIMO system may use the probability of the user device 102A appearing at a predicted future location and compare it to the probability of other user devices 102 also appearing within its coverage area. Signaling and network load decisions may be planned in advance based at least in part on these probabilities of future user device locations. As discussed above, a user device 102 may not receive a signal or may receive an altered signal based upon the probabilities of other user devices appearing at predicted future locations. For example, the user device 102 may receive a signal wide enough to cover multiple user devices 102 rather than a receiving a narrow signal that is directed only to the user device 102.

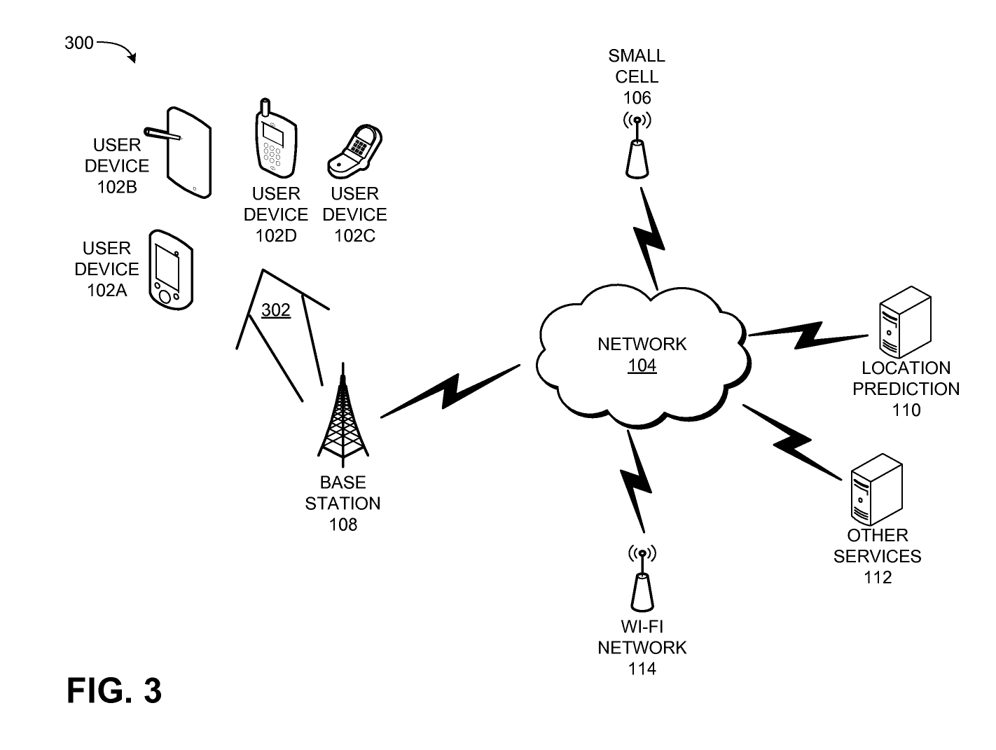

Referring now to FIG. 3, additional details regarding reconfiguring wireless networks by predicting future user device locations are described. In particular, the system 300 illustrates the base station 108 providing a single directional signal 302 to multiple user devices 102A-D. The base station 108 may have utilized information from the location prediction module 110 in deciding to send out one directional signal 302 to multiple user devices 102A-D. The location prediction module 110 may provide a plurality of future user device locations to the network 104.

When these predicted future user device locations appear close enough together, the base station 108 may send out a single wide directional signal 302 to all the user devices 102A-D. The base station 108 is capable of broadcasting to a plurality of user devices 102 through a single link. In millimeter wave systems, this broadcast via a single future directional link 302 may be used to send the same data to multiple user devices 102. For example, the base station 108 may broadcast a live video feed that multiple user devices 102 are viewing at the same time. Alternatively, a MU-MIMO system may transmit different data to the multiple user devices 102 using a beam wide enough to cover the data needs for each of the user devices 102. This type of beam planning for the EHF spectrum is discussed above with regard to FIG. 1.

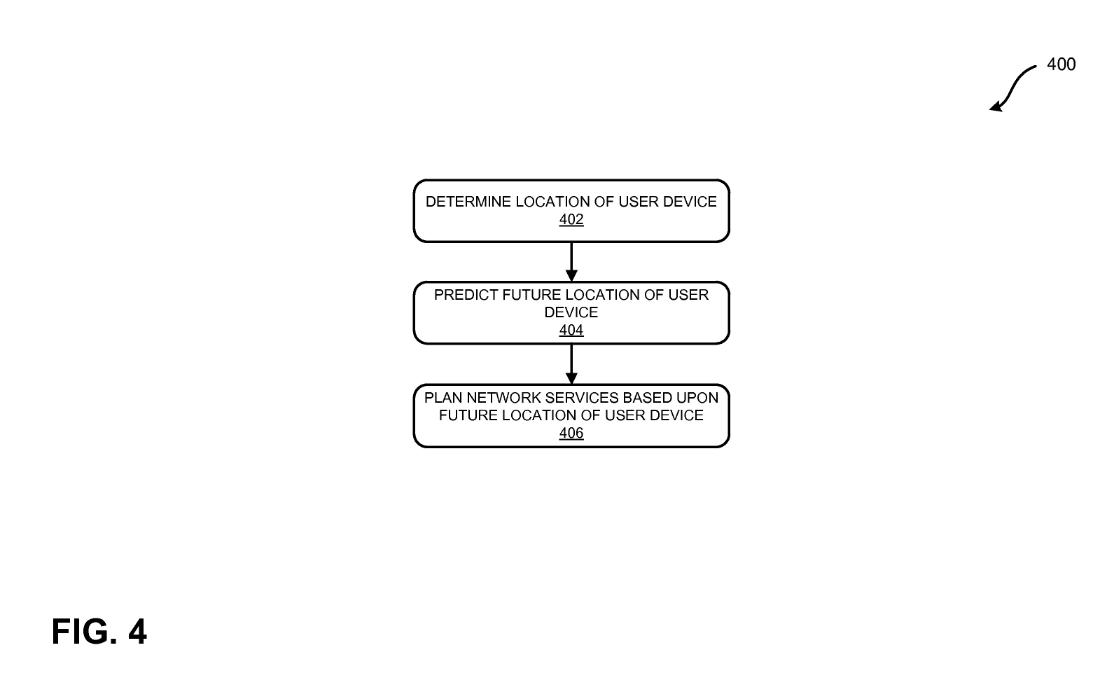

FIG. 4 is a flow diagram showing an example process 400 that may be implemented using the system illustrated in FIG. 1. The logical operations described herein are implemented (1) as a sequence of computer implemented acts or program modules running on a computing system and/or (2) as interconnected hardware machine logic circuits or circuit modules within the computing system. The implementation is a matter of choice dependent on the performance and other requirements of the computing system. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

The process 400 includes operation 402, where a determination of the location of a user device 102 is made. The determination of the location of the user device 102 may be made by a network location module. Additionally or alternatively, the location of the user device 102 may be made by the base station 108 or offload network or be received from the user device 102. From operation 402, the process 400 proceeds to operation 404, where a future location of the user device 102 is predicted. As discussed above, the future location of the user device 102 may be determined by a location prediction module 110. The location prediction module 110 may predict the future location based on the current location of the user device 102 and multiple potential destinations within a threshold range. As the user device 102 moves, the location prediction module 110 may update the multiple potential destinations.

The location prediction module 110 may be located as a network service in a cloud computing architecture. Additionally or alternatively, the location prediction module 110 could be located elsewhere in the network 104, such as a base station 108. The future location of the user device 102 may be determined by a number of factors, including the location of the user device 102 determined in operation 402. Other factors that may determine a predicted future location of the user device 102 may include traffic conditions and/or weather conditions within the geographic area of the network 104. For example, the process may use a traffic alert of a road closing to diminish the probabilities of the user device 102 appearing on that road or areas that are only accessible via the road.

From operation 404, the process 400 proceeds to operation 406 where network services are planned based upon the predicted future location of the user device 102. As discussed above with regard to FIGS. 1-3, a network 104 can utilize the predicted future location of the user device 102 in a variety of ways. The network services that are planned may include providing decisions to offload user devices 102, sending directional signals to user devices 102 or determining future channel conditions. For example, a network may determine to offload a user device 102 from a base station 108 to a Wi-Fi network 114 based upon a predicted future location because of a lack of capacity at the base station 108.

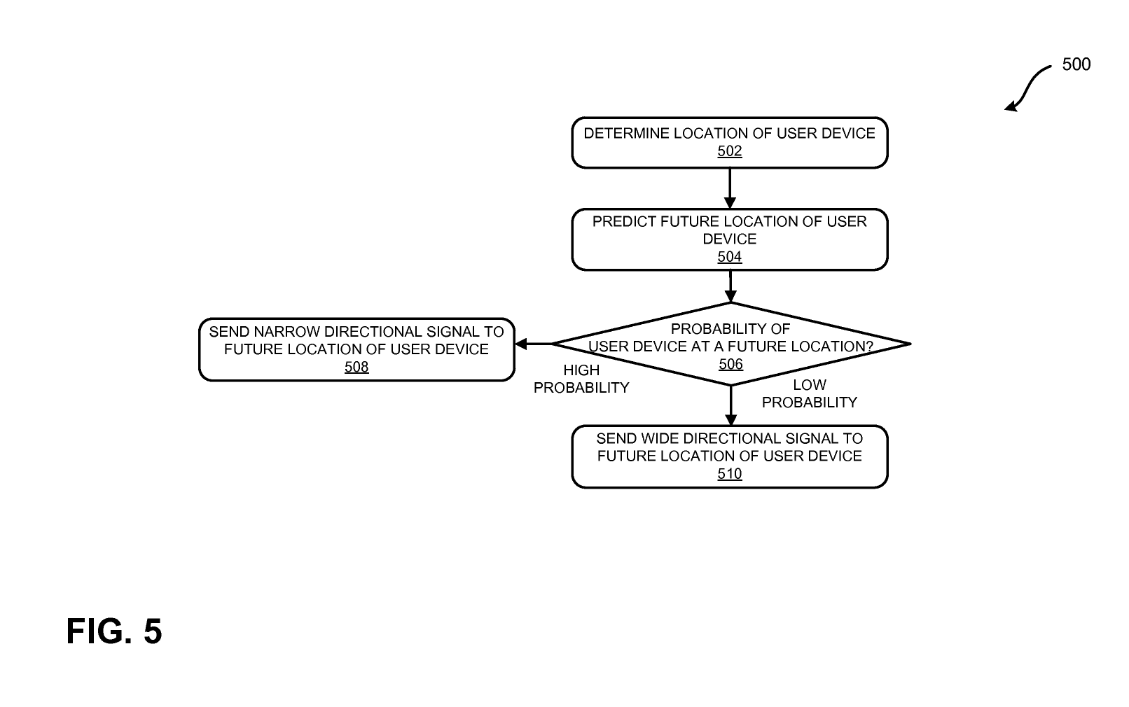

With regard to FIG. 5, additional details will be provided regarding the technologies presented herein for sending a directional signal to a predicted future location of a user device 102. The process 500 sends out directional signals with properties based upon the probability of the user device 102 appearing at the predicted future location.

The process 500 includes operation 502, where a determination of a current location of a user device 102 is made. From operation 502, the process 500 proceeds to operation 504, where a future location of the user device 102 is predicted. As discussed above, the future location of the user device 102 may be predicted by a location prediction module 110. Additionally or alternatively, the location prediction module 110 may determine the future location of the user device 102 based upon historical data of the user device 102. For example, the location prediction module 110 may predict that the future location of the user device 102 is at home because it is Friday at 5:00 pm and the user device 102 is in motion towards home from work.

From operation 504, the process 500 proceeds to operation 506, where a determination is made of the probability of the user device 102 appearing at the predicted future location. Using the previous example, predicted future locations will have a lower probability the farther they are located from home. From operation 506, the process 500 may proceed to operation 508 if it is determined that there is a high probability that the user device 102 will appear at the predicted future location. The high probability can be relative to a threshold level. Additionally or alternatively, the high probability can be relative to probabilities of other user devices 102 appearing at predicted future locations. For example, when a Wi-Fi network 114 with limited capacity has a number of user devices 102 with predicted future locations in its range, the Wi-Fi network 114 may choose to only send directional signals to the user devices 102 with the highest probability of appearing within its network. At operation 508, a narrow direction signal is sent to the predicted future location of the user device 102.

From operation 506, the process 500 may proceed to operation 510 if it is determined that there is a low probability that the user device 102 will appear at the predicted future location. The low probability can be relative to a threshold level. Additionally or alternatively, the low probability can be relative to probabilities of other user devices 102 appearing at predicted future locations. At operation 510, a wide direction signal is sent to the predicted future location of the user device 102.

Varying the width of the directional beam to a user device 102 in operations 508 and 510 illustrate that the directional beam can be altered. Altering the directional beam based upon the user device 102 appearing at the predicted future location allows for increased network efficiency by focusing the directional beam to a limited width.

The process 500 displays the determination from operation 506 as either high or low probability, relative to a threshold, with the result of the direction signal being either narrow or wide. This example is provided for illustrative purposes and is not to be construed as limiting, as a range of probabilities other than a probability relative to one threshold are possible with a resulting range of directional signal widths. Additionally, process 500 illustrates a single predicted future location of the user device 102. As discussed above with regard to FIG. 2, multiple predicted future locations of the user device 102 may be calculated. Likewise, multiple signals, each with its own width, may be calculated for each of the predicted future locations of the user device 102.

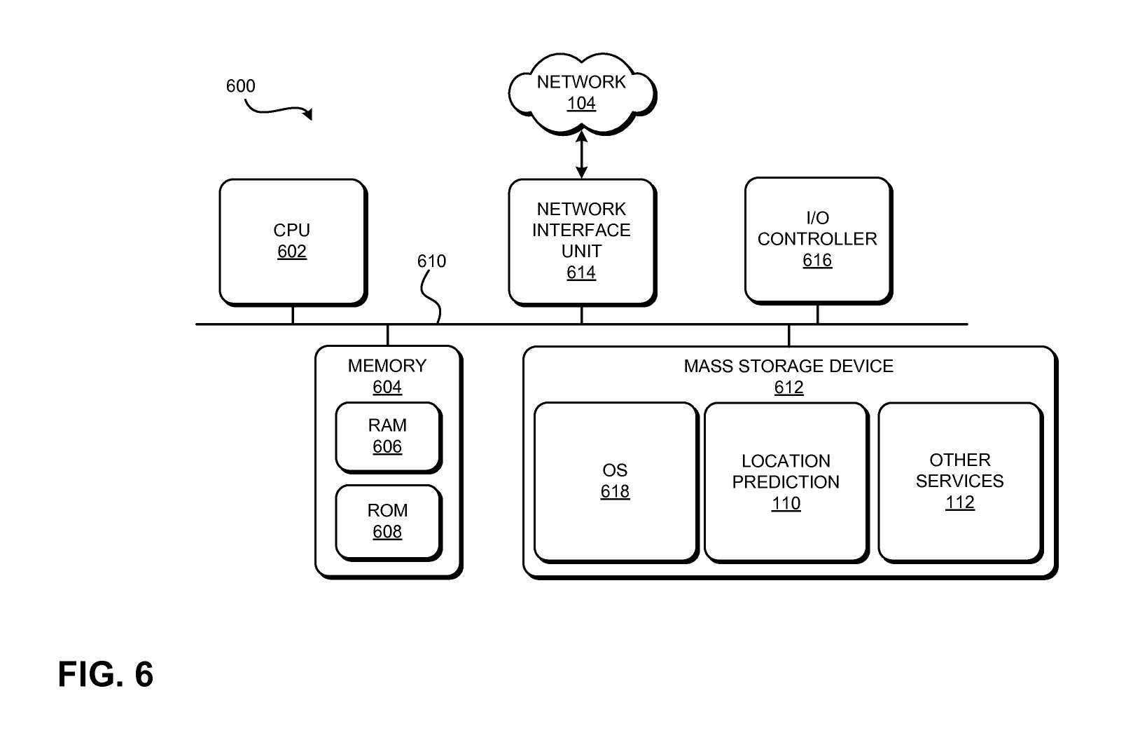

FIG. 6 illustrates a computer architecture 600 for a device capable of executing some or all of the software components described herein for reconfiguring wireless networks by predicting future user device locations. Thus, the computer architecture 600 illustrated in FIG. 6 illustrates an architecture for a server computer, base station, small cell, Wi-Fi hub, and/or a network server. The computer architecture 600 may be utilized to execute any or all aspects of the software components presented herein.

The computer architecture 600 illustrated in FIG. 6 includes a central processing unit 602 (“CPU”), a system memory 604, including a random access memory 606 (“RAM”) and a read-only memory (“ROM”) 608, and a system bus 610 that couples the memory 604 to the CPU 602. A basic input/output system containing the basic routines that help to transfer information between elements within the computer architecture 600, such as during startup, is stored in the ROM 608. The computer architecture 600 further includes a mass storage device 612 for storing an operating system (“OS”) 618 and one or more application programs including, but not limited to, the location prediction module 110, and the other services module 112. Other executable software components and data might also be stored in the mass storage device 612.

The mass storage device 612 is connected to the CPU 602 through a mass storage controller (not shown) connected to the bus 610. The mass storage device 612 and its associated computer-readable media provide non-volatile storage for the computer architecture 600. Although the description of computer-readable media contained herein refers to a mass storage device, such as a hard disk or compact disc read-only memory (“CD-ROM”) drive, computer-readable media can be any available computer storage media or communication media that can be accessed by the computer architecture 600.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, radio frequency (RF), infrared and other wireless media.

By way of example, and not limitation, computer storage media includes volatile and non-volatile, removable and non-removable media implemented in any method or technology for storage of information such as computer-readable instructions, data structures, program modules or other data. For example, computer media includes, but is not limited to, RAM, ROM, erasable programmable read only memory (“EPROM”), electrically erasable programmable read-only memory (“EEPROM”), flash memory or other solid state memory technology, CD-ROM, digital versatile disks (“DVD”), high definition digital versatile disks (“HD-DVD”), BLU-RAY, or other optical storage, magnetic cassettes, magnetic tape, magnetic disk storage or other magnetic storage devices, or any other medium that can be used to store information and which can be accessed by a computer. As used herein, “computer storage media,” and variations thereof, does not include communication media.

According to various configurations, the computer architecture 600 may operate in a networked environment using logical connections to remote computers through a network such as the network 104. The computer architecture 600 may connect to the network 104 through a network interface unit 614 connected to the bus 610. It should be appreciated that the network interface unit 614 also may be utilized to connect to other types of networks and remote computer systems. The computer architecture 600 also may include an input/output controller 616 for receiving and processing input from a number of other devices (not shown in FIG. 6). Similarly, the input/output controller 616 may provide output to an output device (also not shown in FIG. 6).

The software components described herein may, when loaded into the CPU 602 and executed, transform the CPU 602 and the overall computer architecture 600 from a general-purpose computing system into a special-purpose computing system customized to facilitate the functionality presented herein. The CPU 602 may be constructed from any number of transistors or other discrete circuit elements, which may individually or collectively assume any number of states. More specifically, the CPU 602 may operate as a finite-state machine, in response to executable instructions contained within the software modules disclosed herein. These computer-executable instructions may transform the CPU 602 by specifying how the CPU 602 transitions between states, thereby transforming the transistors or other discrete hardware elements constituting the CPU 602.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Additional or alternative transformations of physical media are possible without departing from the scope and spirit of the present description, with the foregoing examples provided only to facilitate this discussion.

In light of the above, it should be appreciated that many types of physical transformations take place in the computer architecture 600 in order to store and execute the software components presented herein. It also should be appreciated that the computer architecture 600 may include other types of computing devices. It is also contemplated that the computer architecture 600 may not include all of the components shown in FIG. 6, may include other components that are not explicitly shown in FIG. 6, or may utilize an architecture completely different than that shown in FIG. 6.

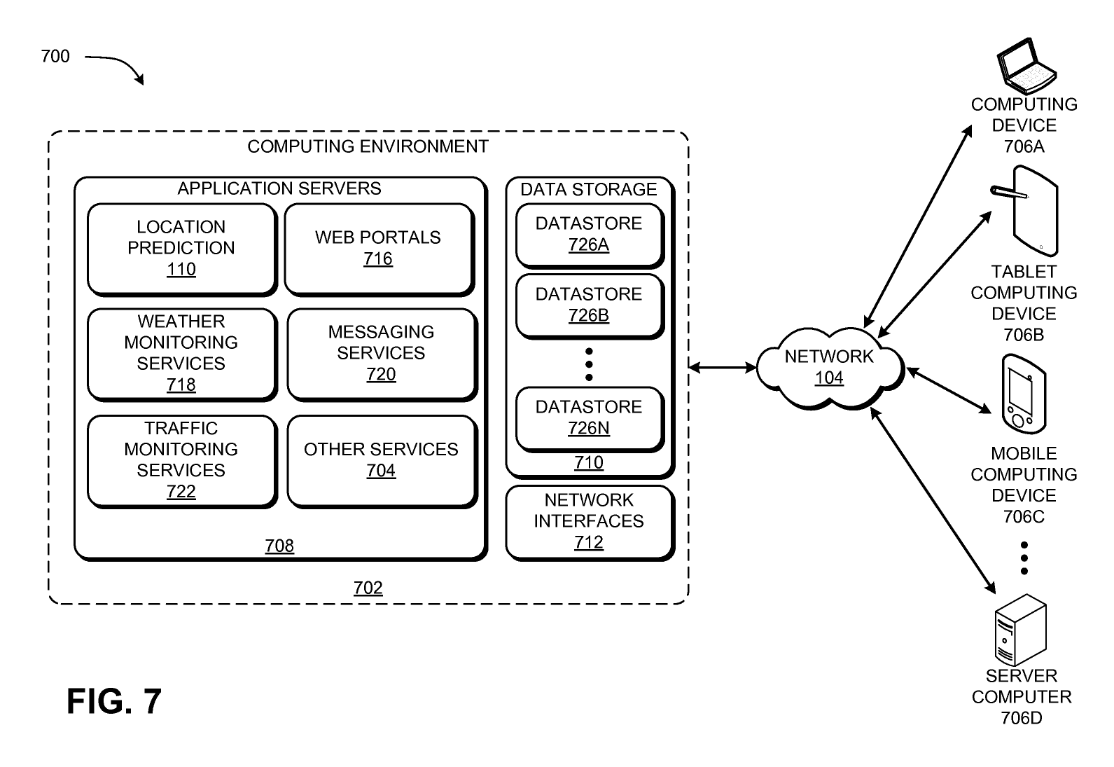

FIG. 7 illustrates an example distributed computing environment 700 capable of executing the software components described herein for reconfiguring wireless networks by predicting future user device locations. Thus, the distributed computing environment 700 illustrated in FIG. 7 can be used to provide the functionality described herein with respect to the FIGS. 1-5. Computing devices in the distributed computing environment 700 thus may be utilized to execute any aspects of the software components presented herein.

According to various implementations, the distributed computing environment 700 includes a computing environment 702 operating on, in communication with, or as part of the network 104. The network 104 also can include various access networks. One or more client devices 706A-706N (hereinafter referred to collectively and/or generically as “clients 706”) can communicate with the computing environment 702 via the network 104 and/or other connections (not illustrated in FIG. 7).

In the illustrated configuration, the clients 706 include a computing device 706A such as a laptop computer, a desktop computer, or other computing device; a slate or tablet computing device (“tablet computing device”) 706B; a mobile computing device 706C such as a mobile telephone, a smart phone, or other mobile computing device; a server computer 706D; and/or other devices 706N. It should be understood that any number of clients 706 can communicate with the computing environment 702. It should be understood that the illustrated clients 706 and computing architectures illustrated and described herein are illustrative, and the techniques described herein are not limited to performance using the illustrated devices and architectures.

In the illustrated configuration, the computing environment 702 includes application servers 708, data storage 710, and one or more network interfaces 712. According to various implementations, the functionality of the application servers 708 can be provided by one or more server computers that are executing as part of, or in communication with, the network 104. The application servers 708 can host various services, portals, and/or other resources. In the illustrated configuration, the application servers 708 host one or more location prediction modules 110. It should be understood that this configuration is illustrative, and should not be construed as being limiting in any way. The application servers 708 also host or provide access to one or more web portals, link pages, web sites, and/or other information (“web portals”) 716.

According to various implementations, the application servers 708 may also include one or more messaging services 720. The messaging services 720 can include, but are not limited to, instant messaging services, chat services, forum services, electronic mail (“email”) services, and/or other communication services.

Additionally, the application servers 708 also may include one or more weather monitoring services 718 and one or more traffic monitoring services 722. As shown in FIG. 7, the application servers 708 also can host other services, applications, portals, and/or other resources (“other resources”) 704. The other resources 704 can include, but are not limited to, the functionality described above as being provided by the other services module 112. Also, the weather monitoring services 718 and the traffic monitoring services 722 may be provided by the other services module 112. It thus can be appreciated that the computing environment 702 can provide integration of the concepts and technologies disclosed herein provided herein for reconfiguring wireless networks by predicting future user device locations with various messaging, location prediction, and/or other services or resources.

As mentioned above, the computing environment 702 can include the data storage 710. According to various implementations, the functionality of the data storage 710 is provided by one or more databases operating on, or in communication with, the network 104. The functionality of the data storage 710 also can be provided by one or more server computers configured to host data for the computing environment 702. The data storage 710 can include, host, or provide one or more real or virtual datastores 726A-726N (hereinafter referred to collectively and/or generically as “datastores 726”). The datastores 726 are configured to host data used or created by the application servers 708 and/or other data.

The computing environment 702 can communicate with, or be accessed by, the network interfaces 712. The network interfaces 712 can include various types of network hardware and software for supporting communications between two or more computing devices including, but not limited to, the clients 706 and the application servers 708. It should be appreciated that the network interfaces 712 also may be utilized to connect to other types of networks and/or computer systems.

It should be understood that the distributed computing environment 700 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 700 provides the software functionality described herein as a service to the clients 706.

### Example Clauses

The following example clauses describe additional techniques that may be used alone or in combination.

Clause 1: An apparatus for network load management, the apparatus comprises: a processor; a memory communicatively coupled to the processor; and a program executable by the processor from the memory and which, when executed by the processor, causes the processor to: determine a location of a user device; obtain a predicted future location of the user device that is based at least in part on the location of the user device; query a network repository to identify an offload network that is within range of the predicted future location of the user device; determine a predicted amount of time that the user device is predicted to be within range of the offload network; determine whether to offload the user device from the network to the offload network based at least in part on the amount of time that the user device is predicted to be within range of the offload network; and send instructions to offload the user device from the network to the offload network.

Clause 2: The apparatus of clause 1, wherein the determination of the predicted amount of time that the user device is predicted to be within range of the offload network is based on at least one of: a proximity of the predicted future location of the user device to a center of the offload network; a geographic size of the offload network; or a predicted rate of motion of the user device at the predicted future location.

Clause 3: The apparatus of clauses 1-2, wherein the offload network comprises a Wi-Fi network or a small cell network.

Clause 4: The apparatus of clauses 1-3, wherein the determination whether to offload the user device from the network to the offload network is further based on at least one of: a current load on the network; or a cost associated with offloading the user device.

Clause 5: The apparatus of clauses 1-4, wherein the determination of the predicted amount of time that the user device is predicted to be within range of the offload network is based at least in part on a predicted route of the user device.

Clause 6: The apparatus of clauses 1-5, wherein determining whether to offload the user device from the network comprises determining whether the offload network meets a threshold level of quality, the threshold level of quality based at least upon a signal strength of the offload network.

Clause 7: The apparatus of clauses 1-6, wherein obtaining the predicted future location comprises receiving the predicted future location from a remote location prediction service.

Clause 8: A computer-implemented method for network management, the method comprising: determining a location of a user device; obtaining a predicted future location of the user device based at least in part on the location of the user device; determining a probability of the user device appearing at the predicted future location; and sending a directional signal from the network to the predicted future location of the user device based at least in part on the probability of the user device appearing at the predicted future location.

Clause 9: The computer-implemented method of clause 8, wherein the directional signal comprises a beam having a width inversely proportional to the probability of the user device appearing at the predicted future location.

Clause 10: The computer-implemented method of clauses 8-9, wherein the directional signal comprises a beam having a width, the width of the beam of the directional signal being based at least in part on a content of data transported by the directional signal.

Clause 11: The computer-implemented method of clauses 8-10, wherein the directional signal comprises a plurality of signals from a plurality of antennas.

Clause 12: The computer-implemented method of clauses 8-11, wherein the plurality of signals from the plurality of antennas comprises a plurality of directional signals directed toward the predicted future location of the user device, the user device comprising a second plurality of antennas.

Clause 13: The computer-implemented method of clauses 8-12, further comprising amplifying the plurality of signals at the predicted future location of the user device based at least in part on sending the plurality of signals as a plurality of sine waves.

Clause 14: The computer-implemented method of clauses 8-13, further comprising sending a plurality of directional signals to a plurality of predicted future locations of the user device.

Clause 15: The computer-implemented method of clauses 8-14, wherein a number and a size of the plurality of directional signals are based at least in part on a probability of the user device appearing at each of the plurality of predicted future locations of the user device.

Clause 16: A computer-implemented method for network management, the method comprising: determining a location of a user device; predicting a future location of the user device; predicting one or more future wireless channel conditions at the predicted future location of the user device; and configuring a link between a first plurality of antennas at the user device and a second plurality of antennas at a wireless network access point proximate the predicted future location, according to the predicted one or more future wireless channel conditions.

Clause 17: The computer-implemented method of clause 16, further comprising sending a directional signal from a network to the predicted future location of the user device, the directional signal comprising a width inversely proportional to a probability of the user device appearing at the predicted future location.

Clause 18: The computer-implemented method of clauses 16-17, further comprising: receiving at the second plurality of antennas, a plurality of signals from a plurality of user devices, the plurality of user devices including the user device; and computing, from the plurality of signals from the plurality of user devices, data sent from the user device.

Clause 19: The computer-implemented method of clauses 16-18, further comprising determining signal conditions for the user device based at least in part on a probability of the predicted future location of the user device and a number of user devices located within a proximity of the user device.

Clause 20: The computer-implemented method of clauses 16-19, further comprising determining signal conditions for more than one user device based at least in part on determining whether data sent to the more than one user device contains common information.

### CONCLUSION

Based on the foregoing, it should be appreciated that technologies for reconfiguring wireless networks by predicting future user device locations have been disclosed herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described herein may be implemented as a computer-controlled apparatus, a process implemented at least in part by a computer, a computing system, or as an article of manufacture such as a computer-readable medium. The subject matter described above is provided by way of illustration only and should not be construed as limiting. Various modifications and changes may be made to the subject matter described herein without following the example configurations and applications illustrated and described, and without departing from the true spirit and scope of the present invention, which is set forth in the following claims.

What is claimed is:

1. An apparatus for network load management, the apparatus comprises:
a processor;
a memory communicatively coupled to the processor; and
a program executable by the processor from the memory and which, when executed by the processor, causes the processor to:
determine a location of a user device;
obtain a predicted future location of the user device that is based at least in part on the location of the user device;
query a network repository to identify an offload network that is within range of the predicted future location of the user device;
determine a predicted amount of time that the user device is predicted to be within range of the offload network;
determine whether to offload the user device from the network to the offload network based at least in part on the amount of time that the user device is predicted to be within range of the offload network; and
send instructions to offload the user device from the network to the offload network.

2. The apparatus of claim 1, wherein the determination of the predicted amount of time that the user device is predicted to be within range of the offload network is based on at least one of:
a proximity of the predicted future location of the user device to a center of the offload network;
a geographic size of the offload network; or
a predicted rate of motion of the user device at the predicted future location.

3. The apparatus of claim 1, wherein the offload network comprises a Wi-Fi network or a small cell network.

4. The apparatus of claim 1, wherein the determination whether to offload the user device from the network to the offload network is further based on at least one of:
a current load on the network; or
a cost associated with offloading the user device.

5. The apparatus of claim 1, wherein the determination of the predicted amount of time that the user device is predicted to be within range of the offload network is based at least in part on a predicted route of the user device.

6. The apparatus of claim 1, wherein determining whether to offload the user device from the network comprises determining whether the offload network meets a threshold level of quality, the threshold level of quality based at least upon a signal strength of the offload network.

7. The apparatus of claim 1, wherein obtaining the predicted future location comprises receiving the predicted future location from a remote location prediction service.

8. A computer-implemented method for network management, the method comprising:
determining a location of a user device;
obtaining a predicted future location of the user device based at least in part on the location of the user device;
determining a probability of the user device appearing at the predicted future location; and
sending a directional signal from the network to the predicted future location of the user device based at least in part on the probability of the user device appearing at the predicted future location.

9. The computer-implemented method of claim 8, wherein the directional signal comprises a beam having a width inversely proportional to the probability of the user device appearing at the predicted future location.

10. The computer-implemented method of claim 8, wherein the directional signal comprises a beam having a width, the width of the beam of the directional signal being based at least in part on a content of data transported by the directional signal.

11. The computer-implemented method of claim 8, wherein the directional signal comprises a plurality of signals from a plurality of antennas.

12. The computer-implemented method of claim 11, wherein the plurality of signals from the plurality of antennas comprises a plurality of directional signals directed toward the predicted future location of the user device, the user device comprising a second plurality of antennas.

13. The computer-implemented method of claim 11, further comprising amplifying the plurality of signals at the predicted future location of the user device based at least in part on sending the plurality of signals as a plurality of sine waves.

14. The computer-implemented method of claim 8, further comprising sending a plurality of directional signals to a plurality of predicted future locations of the user device.

15. The computer-implemented method of claim 14, wherein a number and a size of the plurality of directional signals are based at least in part on a probability of the user device appearing at each of the plurality of predicted future locations of the user device.

16. A computer-implemented method for network management, the method comprising:
determining a location of a user device;
predicting a future location of the user device;
predicting one or more future wireless channel conditions at the predicted future location of the user device; and
configuring a link between a first plurality of antennas at the user device and a second plurality of antennas at a wireless network access point proximate the predicted future location, according to the predicted one or more future wireless channel conditions.

17. The computer-implemented method of claim 16, further comprising sending a directional signal from a network to the predicted future location of the user device, the directional signal comprising a width inversely proportional to a probability of the user device appearing at the predicted future location.

18. The computer-implemented method of claim 16, further comprising:
receiving at the second plurality of antennas, a plurality of signals from a plurality of user devices, the plurality of user devices including the user device; and
computing, from the plurality of signals from the plurality of user devices, data sent from the user device.

19. The computer-implemented method of claim 16, further comprising determining signal conditions for the user device based at least in part on a probability of the predicted future location of the user device and a number of user devices located within a proximity of the user device.

20. The computer-implemented method of claim 16, further comprising determining signal conditions for more than one user device based at least in part on determining whether data sent to the more than one user device contains common information.
